(19) United States
(12) Patent Application Publication
(10) Pub. No.: US 2010/0159100 A1
(43) Pub. Date: Jun. 24, 2010

(54) FLAVONOID-RICH CITRUS EXTRACT AND COMPOSITIONS THEREOF

(76) Inventors: Olivier Buysschaert, Pellenberg (BE); Annelieke Nicoline van Ooij, Leuven (BE); Timothy A. Anglea, Windermere, FL (US); A. Reza Kamarei, Apopka, FL (US)

Correspondence Address: PARKS IP LAW/TCCC, 1117 PERIMETER CENTER WEST, SUITE E402, ATLANTA, GA, 30338, US

(21) Appl. No.: 12/340,190

(22) Filed: Dec. 19, 2008

(51) Int. Cl. A23L 2/06; A23L 2/52

(52) U.S. Cl. 426/541; 426/655; 426/590; 426/599; 426/548

(57) ABSTRACT

Flavonoid citrus extract and compositions thereof are provided, wherein the flavonoid citrus extract is derived from the by-product of a citrus extraction process. The flavonoid citrus extract and compositions are especially beneficial as a source for providing important phytochemicals, like flavonoids, which are biologically active in humans. In a particular application, the citrus extract is an orange juice product, which can be added to citrus based beverages, non-citrus based beverages or used as a stand alone juice.

### FIELD OF THE INVENTION

The present invention relates generally to a flavonoid citrus extract and beverage compositions prepared therefrom. The flavonoid citrus extract contains high levels of nutritionally important phytochemicals that can be added to beverages, such as citrus-based and non-citrus-based beverages, or used as a stand-alone juice.

### BACKGROUND OF THE INVENTION

Citrus fruits have long been recognized as containing valuable sources of important nutrients which are biologically active in humans. U.S. Patent Application Publication No. US 2002/006953 A1. Growing evidence suggests that certain phytochemicals found in citrus sources, such as flavonoids and limonoids, play a major role in treating or retarding chronic diseases, including anti-oxidative, anti-carcinogenic, cardiovascular protective, neuro-protective, bone health promotion and anti-inflammatory diseases.

Citrus fruits, such as oranges, contain compounds called phytochemicals that can be included into three major groups: the flavonoids, limonoids and carotenoids. The flavonoids are a group of benzopyran derivatives which occur widely in plants. The flavonoids typically consist of a benzene ring fused with the heterocyclic six-membered ring containing an oxygen atom. Many flavonoids may also exist as glycosides. The flavonoids in citrus also include the flavone polymethoxylated flavone (in oranges). This compound is represented by flavones substituted by methoxy groups and is unique to citrus. The polymethoxylated flavones have shown cholesterol and lipid lowering potential in animals and possibly humans, and the potential for treating diabetes and inflammation.

In citrus fruits, the most predominant flavonoids are the flavanones hesperidin, narirutin and didymin (in oranges). The flavonoid compounds have been studied for their potential use in the treatment of degenerative and infective diseases.

Triterpene derivatives known as limonoids commonly occur in citrus fruits. The liminoids may exist as aglycones, or be linked to a glucose molecule (the glucoside). It is believed that limonoids may be useful in treating ailments associated with cancer, and may also have the potential for treating cardiovascular disease and for antiviral activity.

The carotenoids are tetraterpenoid compounds which occur widely in plants and other photosynthetic organisms. The carotenoid profile of citrus fruits, such as oranges, is complex, and the identity, number and concentration of carotenoids in orange juice is controversial. Zeaxanthin, lutein, β-cryptoxanthin, α-carotene and β-carotene are the major carotenoids in orange juice. These carotenoids are bioavailable, but it is unclear whether the biological effects in humans are related to their antioxidant activity or other non-antioxidant activities. Nevertheless, there are promising animal results regarding the use of beta-cryptoxanthin to reduce the risk of inflammatory disorders, e.g., rheumatoid arthritis and for the prevention of bone loss.

Important quantities of useful naturally- occurring phytochemicals such as flavonoid compounds, including flavones and flavanones, and limonoids are lost during the conventional juice extraction process, which processes juice from the whole fruit or plant and discards the peel, core and/or other components that are considered waste material useful in the production of livestock feed. It is also known that when certain by-products of the juice extraction process, such as the citrus peel is further processed to obtain a natural clouding agent for beverages, such as juices, the level of naturally occurring phytochemicals is usually reduced or removed during the debittering process as it is believed that these phytochemicals detract from the quality of the citrus or plant juice.

Citrus fruits are a growing industry with significant world importance. Citrus fruits, such as oranges, tangerines, mandarin, blood oranges, grapefruit, lemon and limes are utilized primary for juice recovery. The by-products industry also has a potential for growth since products have also been produced from citrus fruit residues. The citrus peel residue is the primary by-product amounting up to 30%, while the cell, core and membrane and frit residues present an additional 20% of the by-product industry. In most cases, this huge amount of waste material is the source for cattle feed only, while in other cases, products such as molasses, oils, D-limonene, pectin and flavonoids can be extracted and used. An alternative use of citrus by-products is concentrating the solid extract to obtain higher solid extracts, which are believed to improve the organoleptic properties by removing of the so called “undesirable components” on resin columns. US Patent Application Publication No. 2004/0081734 A1.

For example, US Patent Application Publication No. 2006/9195089 A1 describes a process of extracting the citrus peel by-product from a citrus juice extraction process, to obtain a refined citrus peel juice which can be used as a filler juice suitable for blending with other juices or as a stand alone juice. In this publication, the peel juice is passed through a debittering column on a divinylbenzene adsorption resin to substantially reduce the level of naturally occurring components, including flavonoids, such as narirutin, hesperidin, limonoids. In '089, flavones, and other components were believed to detract from the quality of the fruit juice. While it is noted that the citrus fruit peel is high in desirable bioactive compounds, '089 teaches the removal of undesirable bitter compounds as well as some of the desirable bioactive compounds.

US Patent Application Publication No. 2006/0141114 A1 also teaches a process for processing any plant material residue, including grape and citrus fruit to produce a secondary juice that can be added to a primary juice.

U.S. Pat. No. 6,506,427 teaches a method for obtaining a super-cloud composition. In this method, at least one of a water soluble extract citrus solids, comprising peel core, cells, peel, frit, and compositions thereof was processed to obtain a retenant containing super-cloud composition. The retenant is said to contain some residues such as hydrocolloids, sugar, proteins, phenolic compounds, and bioflavonoids (esterified by glycosides and non-esterified compositions), but mainly insoluble polyphenols and bioflavonoids, in a solid crystalline form, such as naringine from grapefruit or hesperidin from oranges.

U.S. Pat. No. 7,108,887 discloses a process for enhancing a juice source by reducing or removing naturally occurring components from the juice source. The naturally occurring components that were reduced, includes limonoids, flavonoids, carotenoids polyphenolic compounds and flavones.

Whether during the processing of citrus juice or citrus juice by-products, the prior art shows that important quantities of phtyochemicals such as flavonoids are lost, because either the by-products of the juice process are considered waste, or the level of phtyochemicals in the by-product extraction process have been substantially reduced or removed as these components are thought to contribute undesirable qualities to the clouding agent. While these prior art extraction processes enable the loss, removal or reduction of important naturally occurring phytochemicals in the citrus fruit, the resultant juice is deficient in phytochemicals.

In light of the present state of the art, the present invention provides a flavonoid citrus extract that is rich in phytochemical flavonoids, captures the nutritional benefits of the whole citrus fruit, and can be added back in significant amounts to beverage compositions, such as concentrated citrus juice, single strength citrus juice from concentrate, and not from concentrate citrus juice products, other non-citrus beverages, or used as a stand alone juice.

### SUMMARY OF THE INVENTION

In accordance with the present invention, a flavonoid citrus extract processed from citrus by-product sources, which retains high levels of important phytochemicals of the citrus fruit, without compromising the taste or quality of the extract, can be added to concentrated citrus juice products, single strength citrus juice from concentrate, not from concentrated citrus juice products, other non-citrus beverage products or used as a stand alone juice.

In one embodiment, the invention provides a citrus flavonoid extract comprising at least three flavonoids; and wherein the total amount of the at least three flavonoids in the citrus flavonoid extract is at least 700 mg/liter when reconstituted at 11.8° Brix.

In another embodiment, the invention provides a citrus flavonoid extract comprising at least 700 mg/liter total of hesperidin, narirutin and didymin flavonoids when reconstituted at 11.8° Brix.

In yet another embodiment, the invention provides a juice beverage composition comprising a beverage; a citrus flavonoid extract composition comprising at least three flavonoids; water; and at least one additive.

In another embodiment, the invention provides a juice beverage composition comprising a beverage; a citrus flavonoid extract composition comprising at least three flavonoids; and water.

In another embodiment, the invention provides a juice beverage composition comprising a citrus juice; a citrus flavonoid extract composition comprising at least three flavonoids; water; and at least one additive.

In another embodiment, the invention provides juice beverage composition comprising a citrus juice; a citrus flavonoid extract composition comprising at least three flavonoids; and water.

In yet another embodiment, the invention provides a juice beverage composition comprising a citrus flavonoid extract composition comprising at least 700 mg/liter total of hesperidin, narirutin and didymin flavonoids when reconstituted at 11.8° Brix; and water.

In a further embodiment, the compositions containing the citrus flavonoid extract and beverage are provided. The combination of the extract and beverage produces a composition having a higher total flavonoid content, as compared to the beverage alone.

Other aspects, objects and advantages of the present invention will be understood from the following description according to the preferred embodiments of the present invention, specifically including stated and the unstated combinations of the various features which are described herein.

### DETAILED DESCRIPTION OF THE INVENTION

The flavonoid-rich citrus extract is prepared from a substantially raw core component by-product that is separated from a conventional citrus juice extraction process using a conventional extractor. The separated substantially raw core component is recovered and transported with screw conveyors to mills to reduce the raw core component into smaller pieces to provide a comminuted core. The communited substantially raw core typically has a size of from about 0.5 mm to about 1.5 cm. Alternatively, a by-product such as a substantially citrus peel component, or the like, may also be used to produce a flavonoid citrus extract. The term “substantially” means at least 50% of the core component, or other citrus by-product, such as citrus peel or the like from a conventional citrus juice extraction process.

The resulting comminuted core is passed to a de-pectinization tank for mixing the comminuted core with water. The ratio of comminuted core to water is approximately 50:50. To the comminuted core and water mixture, an enzyme is added. Typically a 100 ppm concentration of an enzyme is added to a de-pectinization tank. The enzyme may be ROHACEPT® PTE, or a similar type enzyme may be used herein. The mixture of comminuted core, water and enzyme is heated to a temperature of about 50° Celsius for about 20 minutes, to form a liquid flavonoid citrus extract. The concentration of the liquid flavonoid citrus extract may be about 5.5 ° Brix.

The resulting liquid flavonoid citrus extract will move to a finisher in order to remove solid materials. The removed solid materials may be used in the production of animal feed. A further mixer and finisher combination can be provided in order to affect a serial mixing and finishing so as to further refine the material and collect flavonoid extracts in addition to those extracted through the operation of the first mixer and finisher.

The liquid flavonoid citrus extract from the finisher is next fed to an enzyme de-activation device to inactivate enzyme activity. Typically, the liquid flavonoid citrus extract is subject to de-activation for about 4 to about 8 minutes at a temperature of from about 90 to about 100° Celsius.

The resulting enzyme deactivated heated liquid flavonoid citrus extract passes to a decanter and a centrifuge area, which is a two step process that reduces the level of suspended pulp. Typically, the suspended pulp is first reduced in the decanter from about 2 to about 6%, and subsequently the suspended pulp is reduced by centrifugation from about 0.5 to about 1.5%. After the suspended pulp is reduced, the temperature of the liquid flavonoid citrus extract may be reduced to a temperature of from about 50 to about 70° Celsius.

The liquid flavonoid citrus extract located in the centrifuge area moves to one or more debittering columns, for about 10 to about 18 minutes to reduce the level of undesirable bitter compounds, such as limonin to provide a debittered liquid flavonoid citrus extract. This results in the reduction of limonin to from about 0.6 mg to 160 mg/liter at 11.8° Brix. Another compound falling within the limonoids group, e.g., nomilin, can also be reduced by this resin. Typical adsorption resins may be used in the debittering columns. Commercial adsorption systems are available for use in the debittering columns. A polyester adsorption system that can be used for debittering is Bucher Alimentech P495 resin.

The resulting debittered flavonoid citrus extract contains levels of flavonoids, i.e., flavanones of at least 700 to at least 5,000 mg/ liter when reconstituted to 11.8° Brix. The preferred level of flavanones in the flavonoid citrus extract is at least 1500 mg/liter to about 4800 mg/liter reconstituted to 11.8° Brix. The most preferred level of flavanones in the flavanoid citrus extract is at least 2000 to at least 3000 mg/liter when reconstituted at 11.8° Brix. The debittering columns do not remove most of the flavonoids such as flavanones that may naturally occur in citrus fruit. Examples of compounds falling within the flavonoid group which are found in citrus fruits, such as oranges, are hesperidin, naritutin, didymin, and polymethoxy flavones. The individual and total concentration of the flavanones hesperidin, narirutin and didymin are measured and verified by an HPLC method.

Debittered flavonoid citrus extract flows into a pasteurization and concentration area, and pasteurized at a temperature of from about 90 to about 100° C., for about 0.5 to about 1.5 minutes. The citrus extract was then held in a commercial T.A.S.T.E. Evaporator to be concentrated to 65° Brix.

The flavonoid citrus extract can be prepared from the by-product of any citrus fruit, including, but not limited to oranges, mandarins, tangerines, blood oranges grapefruits, lemons and limes, or the like, alone or in combinations.

The resultant liquid flavonoid citrus extract is collected and blended. Optionally, citric acid may be added to adjust the pH to the desirable value. The liquid flavonoid citrus extract is packaged and stored. The liquid flavonoid citrus extract may be packed aseptically or frozen. The liquid flavonoid citrus extract may be stored for at least two years.

The liquid flavonoid citrus extract of this invention contains high levels of important flavonoids, as described above, which may be added to beverages, such as concentrated citrus juice, single strength citrus juice from concentrate, and not from concentrate citrus juice products, other non-citrus beverages, or used as a stand-alone juice.

The term “citrus” is meant to include all varieties from the commercially important species, such as Sweet orange (Citrus sinensis), Mandarin and Tangerine (Citrus reticulata), Grapefruit (Citrus paradisi), Lemon (Citrus limon) and Lime (Citrus aurantifolia). Preferred citrus fruits are oranges, including varieties such as Shamouti oranges, Valencia, Blood Oranges, Hamlin, Pera, Navel, Pineapple, Valencia, Salustianas, Blond, Parson Brown, and the like, alone or in combinations.

The term “phytonutrients” also known as “phytochemicals” refers to naturally occurring compounds in plants with beneficial effects on human health. There is no established recommended daily allowance (RDA) for phytonutrients and therefore, unlike essential nutrients, their values are not reflected on the Nutritional Facts panel on food products.

The term “flavonoid citrus extract” includes the term “orange extract” as used herein.

The flavonoid citrus extract thus obtained from the referenced process is used to prepare various beverage compositions having high levels of phytochemicals. Examples of suitable phytochemical ranges in a flavonoid citrus extract obtained from the by-product of an orange juice extraction process when reconstituted at 11.8° Brix are from about 700 to about 8,200 mg/liter total of hesperidin, narirutin, and didymin flavanones; from about 350 to about 1,300 mg/liter of limonin glucoside when reconstituted at 11.8° Brix; from about 1 to about 200 mg/liter of polymethoxylated flavones when reconstituted at 11.8° Brix; and from about 0.6 to about 160 mg/liter of limonin when reconstituted at 11.8° Brix. The more preferable phytochemical ranges are from about 1500 to about 4,100 mg/liter of hesperidin, narirutin, and didymin flavanones when reconstituted at 11.8° Brix; from about 350 to about 650 mg/liter limonin glucoside when reconstituted at 11.8° Brix; from about 1 to about 100 mg/liter liter of polymethoxylated flavones when reconstituted at 11.8° Brix; and from about 0.6 to about 80 mg/liter of limonin when reconstituted at 11.8° Brix. The most preferable phytochemical ranges are from about 2,000 to about 3,000 mg/liter total of hesperidin, narirutin, and didymin flavanones when reconstituted at 11.8° Brix; from about 350 to about 600 mg/liter limonin glucoside when reconstituted at 11.8° Brix; from about 1 about 20 mg/liter of polymethoxylated flavones when reconstituted at 11.8° Brix; and from about 0.6 to about 10 mg/liter of limonin when reconstituted at 11.8° Brix.

Additives may include stabilizers, flavorants, anti-oxidants, sugars, high intensity sweeteners, natural sweeteners, juices other than orange juice, acids, citrus pulp, and combinations thereof.

Typical stabilizers, flavorants, and antioxidants that are used in commercial citrus juice beverage production may be added to the present composition. Suitable stabilizers for this invention include pectin, guar gum and the like. Useful flavorants are natural orange flavour, orange restoration flavours and the like. Suitable antioxidants for the invention include vitamin C, rosemary extract, and the like.

Sugar sweeteners generally include saccharine containing components, but not limited to sucrose, dextrose, maltose, dextrin, dried invert sugar, fructose, galactose, corn syrup solids, an the like, alone or in combination.

High intensity sweeteners, such as artificial sweeteners, can also be included in combination with the above sweeteners. Preferred sweeteners include, but are not limited to the sucralose, aspartame, salts of acesulfame, saccharin and its salts, cyclamic acid and its salts, glycyrrhizin, dihydorchalcones, thaumatin, monellin and the like, alone or in combination.

Natural sweeteners, include, but are not limited to stevia, Luo Han Guo, agave nectar, and the like, alone or in combination with the above sweeteners.

Additives, such as citrus pulp may be added to the beverage compositions to reinforce the concept of having the goodness of a whole orange. Typically, pulp can be added up to the same ratio or higher as pulp verses from concentrate citrus juice, or pulp verses not from concentrate citrus juice.

The flavonoid citrus extract and beverage compositions of the present invention may be prepared by blending or mixing homogeneously the ingredients, as commonly used in citrus juice processing, either as a syrup or directly to the final beverage. Ideally, the viscosity of the flavonoid citrus extract should not exceed the viscosity of a regular frozen citrus juice from concentrate at 65° Brix. Most citrus juice processing plants are capable of pumping and mixing standard citrus juice concentrate. Furthermore no special measures are needed for blending in the flavonoid citrus extract, other than industry standard good manufacturing practices applied in bottling plants.

If a heat treatment is desired in the present invention, then the conditions applied are identical to the standard heat processes within the beverage industry. Examples of pasteurization conditions that may be used for the following products are:

### Shelf-Stable Product:

HTST (high temperature, short time) combination of 86° C./40 seconds and package aseptically.
HTST (high temperature, short time) 93° C./3.0 seconds. The product will be packed aseptically.

### Chilled Product:

HTST (high temperature, short time) combination of 80-82° C./2-5 seconds and clean filled.

If in the final application cold-filled compositions are desired (with added preservatives), then no heat treatment is required. Typically, this would apply to low juice containing beverage compositions.

At the appropriate conditions, temperature, shelf life and package, analytical, microbiological and organoleptical quality must be monitored to guarantee a stable product.

In the following examples, the flavonoid citrus extract and compositions were obtained from the by-product of an orange extraction process; however, the invention can be practiced with citrus fruits other than oranges. In the following examples, the flavonoid citrus extract was standardized in order to guarantee a minimum nutritional level, organoleptical, micro-safety and application standards. In general, the flavonoid levels in the present invention were based on the amounts attributed by the specific beverage and/or the citrus flavonoid extract. Illustrations of the disclosure herein are provided in the Examples.

In the following examples, it is critical to understand the variability of total flavonoids typically found in orange juice, as it helps to understand how much flavonoid citrus extract to add and what levels to expect in common juices. For the following examples, various literature sources were reviewed and citrus concentrate suppliers screened to determine the amount of flavonoid citrus extract that would be required for the compositions in this invention.

In nature oranges vary in the content of total flavonoids. Table 1.1 lists the literature reference which shows the flavonoid level of orange juice based beverages. Because of the natural variation of the orange juice concentrate, a range is found between 130-700 ppm.

TABLE 1.1
Concentration of flavonoids in orange juice (ppm) found in literature

| | Processing | | | | Total |
|---|---|---|---|---|---|
| Source | method | Hesperidin | Narirutin | Didymin | flavonoids |
| Rouseff et | Fresh Squeezed | 122-254 | 18-56 | | 149-292 |
| al | | | | | |
| Pupin et al | Hand Squeezed | 260.8 | 48.7 | | 309.5 |
| Pupin et al | Fresh Squeezed-Retail | 266 | 35 | | 301 |
| Pupin et al | Frozen | 634 | 78.3 | | 712.3 |
| | Concentrate-Retail | | | | |
| USDA | Raw Orange Juice | 112.6 (a) | 21.9 (a) | | 134.5 (a) |
| USDA | Frozen Concentrate | 262.1 (a) | 32.7 (a) | | 294.8 (a) |
| Franke et al | Not From | 322 (both) | 60 | | 382 |
| | Concentrate | | | | |
| Vanamala et al | Not From Concentrate | 305 | 41 | 18 | 365 |
| Vanamala et al | From Concentrate | 441 | 67 | 17 | 526 |

Furthermore, citrus suppliers have collected and screened oranges at various times to gain a better understanding of the variation in flavonoids. The screening analysis is done by HPLC method. During the analysis, the various commercial available citrus juice concentrates have been diluted to 11.8° Brix and measured. The variation found on the various commercially available citrus concentrates, as shown in Table 1.2 below, is between 96 mg/liter to about 1110 mg/liter total flavonoids.

TABLE 1.2

| Supplier | Juice | Brix | Reconstituted | Narirutin | Hesperidin | Didymin | Summation |
|---|---|---|---|---|---|---|---|
| Name | Type | concentrate | Brix | (mg/L) | (mg/L) | (mg/L) | (mg/L) |
| Supplier A | Orange | 57.4 | 11.8 | 95 | 472 | 44 | 611 |
| Supplier C | Blood Orange | 50.1 | 11.8 | 46 | 392 | 24 | 462 |
| Supplier E | Murcott | 64.4 | 11.8 | 47 | 35 | 16 | 98 |
| Supplier C | Orange | 61.9 | 11.8 | 84 | 625 | 41 | 751 |
| Supplier A | Orange | 60.3 | 11.8 | 65 | 381 | 24 | 470 |
| Supplier G | Orange | 64.0 | 11.8 | 74 | 582 | 43 | 699 |
| Supplier B | Murcott | 65.2 | 11.8 | 290 | 136 | 84 | 510 |
| Supplier B | Murcott | 65.7 | 11.8 | 287 | 133 | 83 | 503 |
| Supplier G | Orange | 60.6 | 11.8 | 68 | 604 | 27 | 699 |
| Supplier D | Orange | 65.5 | 11.8 | 83 | 653 | 37 | 773 |
| Supplier D | Orange | 64.0 | 11.8 | 73 | 659 | 33 | 765 |
| Supplier D | Orange | 64.3 | 11.8 | 86 | 597 | 33 | 716 |
| Supplier E | Orange | 64.3 | 11.8 | 47 | 37 | 16 | 100 |
| Supplier H | Orange | 63.3 | 11.8 | 120 | 937 | 57 | 1113 |
| | (Shamouti) | | | | | | |
| Supplier H | Orange | 63.3 | 11.8 | 118 | 921 | 56 | 1096 |
| | (Shamouti) | | | | | | |
| Supplier A | Orange | 57.4 | 11.8 | 95 | 472 | 44 | 611 |
| Supplier C | Blood Orange | 50.1 | 11.8 | 46 | 392 | 24 | 462 |
| Supplier E | Murcott | 64.4 | 11.8 | 47 | 35 | 16 | 98 |
| Supplier C | Orange | 61.9 | 11.8 | 84 | 625 | 41 | 751 |
| Supplier A | Orange | 60.3 | 11.8 | 65 | 381 | 24 | 470 |
| Supplier F | Orange | 64.0 | 11.8 | 74 | 582 | 43 | 699 |
| Supplier B | Murcott | 65.2 | 11.8 | 290 | 136 | 84 | 510 |
| Supplier B | Murcott | 65.7 | 11.8 | 287 | 133 | 83 | 503 |
| Supplier G | Orange | 60.6 | 11.8 | 68 | 604 | 27 | 699 |
| Supplier D | Orange | 65.5 | 11.8 | 83 | 653 | 37 | 773 |
| Supplier D | Orange | 64.0 | 11.8 | 73 | 659 | 33 | 765 |
| Supplier D | Orange | 64.3 | 11.8 | 86 | 597 | 33 | 716 |
| Supplier E | Orange | 64.3 | 11.8 | 47 | 37 | 16 | 100 |
| Supplier H | Orange | 63.3 | 11.8 | 120 | 937 | 57 | 1113 |
| | (Shamouti) | | | | | | |
| Supplier H | Orange | 63.3 | 11.8 | 118 | 921 | 56 | 1096 |
| | (Shamouti) | | | | | | |

### EXAMPLE 1

### Flavonoid Extract

A flavonoid citrus extract provided by the process described above was derived from the by-product of an orange juice extraction process and contained 2,036 mg/liter (concentration amount) total of hesperidin, narirutin and didymin flavonoids when reconstituted to 11.8° Brix.

### EXAMPLE 2

### Flavonoid Stand-Alone Beverage Composition

A beverage was prepared by blending and mixing homogeneously the flavonoid citrus extract of example 1 with water, in the same manner as processing a standard orange juice containing beverage, to obtain a stand-alone flavonoid citrus extract beverage containing 4,800 mg/liter total flavonoids reconstituted at 25° Brix. A heat treatment was applied to guarantee the minimum shelf life within the distribution and storage conditions. The process was adjusted by increasing the solids from a lower to higher ° Brix values. For each formula microbiological and sensorical qualities were taken into account. The level of dry solids in this highly enriched flavonoid beverage reached 25° Brix, and had an acceptable taste.

### EXAMPLE 3

### Flavonoid Citrus Extract-Orange Juice Beverage Composition

A flavonoid citrus extract and frozen orange juice concentrate (FC) beverage composition was prepared using the process described in example 2. A base formula (orange juice from concentrate, pulp, water, and restoration flavors, as needed), was prepared using the amounts shown below in Table 2.

TABLE 2

| Ingredient | Dosage g/liter |
|---|---|
| FC orange concentrate 65° Brix | 168.8 |
| Pulp | 88.35 |
| Water | 801.7 |

The base formula in Table 2 was adjusted to compensate for the addition of flavonoid citrus extract, as shown in Table 3 below.

TABLE 3

| Ingredient | Dosage g/liter |
|---|---|
| FC orange concentrate 65° Brix | 168.8 |
| Flavonoid citrus extract (orange), 65° | 66.4 |
| Brix | |
| Pulp | 88.35 |
| Water | 735.3 |

The amount of flavonoid citrus extract used in Table 3, was based on a determination that Brazilian orange juice from concentrate typically ranges from about 563 mg/liter to about 735 mg total flavonoids/liter, and that 600 mg total flavonoids/liter would be taken as the base point for fortifying the composition to ensure that the target flavonoid levels were obtained. A target minimum of 1300 mg/liter total flavonoids was set for the final application. Using these target levels, the amount of total flavonoids/gram in the flavonoid citrus extract, was calculated using a flavonoid citrus extract standardized, amongst other parameters, to 2000 mg total flavonoids/liter at 11.8° Brix. This calculation was converted to determine the amount of flavonoid citrus extract needed to reach 700 mg total flavonoids/liter added, since the minimum target level has been set at 1300 mg total flavonoids/liter (i.e., base point for fortification is 600 mg/liter plus the additional 700 mg total flavonoids provided by the flavonoid citrus extract).

To achieve the desired base level of 600 mg/liter total flavonoids, neither pulp nor orange juice concentrate was removed or diluted. Therefore, an equal amount of water was removed and replaced by the flavonoid citrus extract, or 66.370 g water was replaced by 66.370 g of flavonoid citrus extract/liter water to achieve the additional 700 mg of total flavonoid citrus extract/liter.

The following calculations were made to adjust the pulp level in the beverage composition so that it is comparable to the pulp level in an orange. In determining the amount of pulp in Example 3, the mass balance of oranges processed to obtain orange juice is on average defined as 1000 kg of whole oranges provides 30 kg of pulp. These 1000 kg of oranges also provides 100 kg of frozen orange juice from concentrate (65° Brix). Thus, the pulp calculations for beverages made with frozen orange juice from concentrate are based on a 30/100 ratio of pulp to frozen orange juice from concentrate, which means that 0.3 kg pulp should added per kg concentrate.

| | |
|---|---|
| Amount. of FC (65° Brix): | 168.8 g/liter |
| Pulp level: | 50.64 g/liter (=168.8 * ratio 0.3) |

This ratio 0.3, when multiplied by the total kg of frozen orange juice from concentrate (65° Brix) used in the composition provides the amount of pulp used in this example.

| | |
|---|---|
| Amount of added orange pulp in formula: | 88.35 g/liter |
| This gives the amount of actual pulp: | 61.85 g/liter (=88.35 * 0.7) |

As the orange pulp used, contains only 70% of actual pulp cells, the amount of pulp was multiplied by 0.7.

The composition in this example contains greater than 20% extra pulp (61.85 versus 50.64 g/liter) compared to the expected amount of pulp of a whole orange.

The results analyzed for the composition in Table 3, indicated that the composition contains 1371 to 1404 mg/liter of flavonoid citrus extract. Additionally, the final product was consumer tested to confirm taste acceptability.

### EXAMPLE 4

The flavonoid citrus extract and frozen orange juice concentrate beverage was also prepared as set forth in Example 2; however, the level of pulp in the composition was adjusted. Tables 4 and 5 below, show the starting point for the initial referenced composition, before the level of pulp was adjusted, and the final composition after the level of pulp was adjusted, respectively.

TABLE 4

| Ingredient | Dosage g/liter |
|---|---|
| FC orange concentrate 65° Brix | 174.84 |
| Flavonoid Citrus extract (orange), 65° | 65.0 |
| Brix | |
| Orange pulp, 70% effective pulp | 50 |
| Water | 753.9 |

| | |
|---|---|
| Amount of FC (65 Brix): | 174.84 g/liter |
| Required pulp level: | 52.45 g/liter (=174.84 * ratio 0.3) |

TABLE 5

| Ingredient | Dosage g/liter |
|---|---|
| FC orange concentrate 65° Brix | 174.84 |
| Citrus flavonoid extract (orange), 65° | 65.0 |
| Brix | |
| Orange pulp, 70% effective pulp | 74.93 |
| Water | 728.97 |

| | |
|---|---|
| Amount of orange pulp in initial formula: | 50 g/liter |
| This provides only the amount of | 35 g/liter (=50 * 0.7) |
| actual pulp: | |
| Amount of extra needed orange pulp: | 17.45 g/liter (=52.45 − 35) |
| This gives an amount of total actual pulp: | 74.93 g/liter (=52.45/0.7) |

In this example, the amount of water was reduced accordingly, and the formula described in Table 5 contains the same pulp level compared to the amount of pulp of a whole orange.

### EXAMPLE 5

The flavonoid citrus extract and not from concentrate orange juice (NFC) composition was prepared as set forth in Example 2, using the amounts shown below in Table 6.

TABLE 6

| Ingredient | Dosage g/liter |
|---|---|
| NFC orange concentrate | 926.4 |
| Flavonoid Citrus extract (orange), 65 | 58.5 |
| Brix | |
| Orange pulp, 70% effective pulp | 72.9 |
| Water | 0 |

For the composition in Table 6, it was a determined that the mass balance of oranges processed to obtain orange juice is on average defined (*) as 1000 kg of whole oranges provides 30 kg of pulp. These 1000 kg of oranges also provides 553 kg of a not from concentrate orange juice. Thus, the pulp calculations for beverages made with a not from concentrate orange juice NFC are based on a 30/553 ratio of pulp to not from concentrate orange juice, which means that 0.05425 kg of pulp should be added per kg concentrate.

| | |
|---|---|
| Amount of NFC: | 926.4 g/liter |
| Required pulp level: | 50.26 g/liter (=926.4 * ratio 0.05425) |

This ratio 0.5, when multiplied by the total kg of not from concentrate orange juice used in the composition, provides the amount of pulp used in this example.

| | |
|---|---|
| Amount of added orange pulp in formula: | 72.9 g/liter |
| This gives the amount of actual pulp: | 51.03 g/liter (=72.9 * 0.7) |

As the amount of orange pulp used, contains only 70% of actual pulp cells, the amount of pulp was multiplied by 0.7.

The composition in Table 5 has a slightly higher pulp level (51.03 versus 50.26 g/liter) compared to the expected amount of pulp in relation to a whole orange.

### EXAMPLE 6

### Juice Concentrate verses Flavonoid Citrus Extract

A minimum target total flavonoid level can be achieved by both the addition of orange juice concentrate and/or flavonoid citrus extract (orange). In the results below, the minimum target total flavonoid level was set to 1300 mg total flavonoids per liter. In order to achieve the target, various quantities of juice concentrate and flavonoid citrus extract (orange) were blended into the final application and organoleptically evaluated (Table 6). The flavonoid citrus extract (orange) was standardized amongst others, on a total flavonoid level of 2000 mg/liter (diluted at 11.80° Brix) and concentrated to 65° Brix.

TABLE 7

| | | | | Total | Total | |
|---|---|---|---|---|---|---|
| Orange | | | Total | flavonoids | flavonoid | % orange |
| concentrate | Orange extract | | flavonoids | orange | level final | juice final |
| (g/l) | (g/l) | Brix | concentrate | extract | application | application |
| 168.78 | 65.04 | 15.35 | 600 | 700 | 1300 | 98.0 |
| 140.00 | 75.00 | 14.17 | 498 | 802 | 1300 | 81.3 |
| 120.00 | 81.00 | 13.35 | 427 | 873 | 1300 | 69.6 |
| 100.00 | 88.00 | 12.53 | 355 | 945 | 1300 | 58.0 |
| 136.00 | 76.00 | 14.00 | 551 | 749 | 1300 | 78.9 |
| 111.00 | 84.00 | 13.00 | 462 | 838 | 1300 | 64.4 |
| 87.00 | 92.00 | 12.00 | 370 | 930 | 1300 | 50.5 |
| 75.00 | 96.00 | 11.50 | 323 | 977 | 1300 | 43.5 |

In Table 7, it is also shown that by decreasing the levels of orange concentrate; the quantities of flavonoid citrus extract (orange) do not increase equally, resulting in [1] significant Brix differences and [2] different percentages of orange juice into the final application. All beverages were evaluated organoleptically and found to be acceptable.

In the above examples, it is critical that the total flavonoid level is monitored and linked to the added orange juice amount (FC/NFC) in the matrix. For example, if 100% orange juice at 11.2° Brix contains a total flavonoid level ranging from about 600 mg to 700 mg per liter and the minimum target of the final application has been set to 400 mg per liter. Thus in the original matrix there is 179.56 g orange concentrate at 65° Brix needed per liter of final product. The 179.56 g orange concentrate provides at a minimum, 600 mg per liter. Therefore the quantity of juice concentrate must be adjusted accordingly. Specifically, 179.56*(400/600) or 119.70 g orange concentrate at 65° Brix needed per liter final product to achieve a minimum level of 400 mg per liter.

It should be apparent that the foregoing relates only to the preferred embodiments of the present application and that numerous changes and modifications may be made herein by one of ordinary skill in the art without departing from the general spirit and scope of the invention as defined by the following claims and equivalents thereof.

1. A citrus flavonoid extract comprising:
at least three flavonoids; and
wherein the total amount of the at least three flavonoids in the citrus flavonoid extract is at least 700 mg/liter when reconstituted at 11.8° Brix.

2. The citrus flavanoid extract of claim 1, wherein the at least three flavonoids are hesperidin, narirutin and didymin.

3. The citrus flavonoid extract of claim 1, wherein the citrus flavonoid extract is obtained from the by-product of an orange juice extraction process.

4. The citrus flavonoid extract of claim 3, wherein the by-product is substantially the orange core component.

5. The citrus flavonoid extract of claim 3, wherein the by-product is substantially the orange peel component.

6. A citrus flavonoid extract comprising:
at least 700 mg/liter total of hesperidin, narirutin and didymin flavonoids when reconstituted at 11.8° Brix

7. The citrus flavonoid extract of claim 6, wherein the citrus flavonoid extract is obtained from the by-product of an orange juice extraction process.

8. The citrus flavonoid extract of claim 7, wherein the by-product is substantially the orange core component.

9. The citrus flavonoid of claim 7, wherein the by-product is substantially the orange peel component.

10. A juice beverage composition comprising:
a beverage;
a citrus flavonoid extract composition comprising at least three flavonoids;
water; and
at least one additive.

11. The juice beverage composition of claim 10, wherein the beverage is selected from the group consisting of concentrated citrus juice, single strength citrus juice from concentrate, not from concentrate citrus juice products and non-citrus juices.

12. The juice beverage composition of claim 10, wherein the total amount of the at least three flavonoids in the flavonoid citrus extract is at least 700 mg/liter flavonoids when reconstituted at 11.8° Brix

13. The juice beverage composition of claim 10, wherein the at least three flavonoids are hesperidin, narirutin and didymin.

14. The juice beverage composition of claim 10, wherein the additive is selected from the group consisting of stabilizers, flavorants, anti-oxidants, sugar sweeteners, high intensity sweeteners, natural sweeteners, juices other than orange juice, acids, and citrus pulp.

15. The juice beverage composition of claim 10, wherein the additive is a natural sweetener.

16. The juice beverage composition of claim 10, wherein the citrus flavonoid extract is obtained from the by-product of an orange juice extraction process.

17. The juice beverage composition of claim 16, wherein the by-product is substantially the orange core component.

18. The juice beverage composition of claim 16, wherein the by-product is substantially the orange peel component.

19. A juice beverage composition comprising:
a beverage;
a citrus flavonoid extract composition comprising at least three flavonoids; and
water.

20. A juice beverage composition comprising:
a citrus juice;
a citrus flavonoid extract composition comprising at least three flavonoids;
water; and
at least one additive.

21. The juice beverage composition of claim 20, wherein the citrus juice is selected from the group consisting of concentrated citrus juice, single strength citrus juice from concentrate and not from concentrate citrus juice products.

22. The juice beverage composition of claim 20, wherein the citrus juice is orange juice.

23. The juice beverage composition of claim 20, wherein the total amount of the at least three flavonoids is at least 700 mg/liter when reconstituted at 11.8° Brix.

24. The juice beverage composition of claim 20, wherein the additive is selected from the group consisting of stabilizers, flavorants, anti-oxidants, sugar sweeteners, high intensity sweeteners, natural sweeteners, juices other than orange juice, acids, and citrus pulp.

25. The juice beverage composition of claim 24, wherein the additive is a natural sweetener.

26. The juice beverage composition of claim 20, wherein the citrus flavonoid extract is obtained from the by-product of an orange juice extraction process.

27. A juice beverage composition comprising:
a citrus juice;
a citrus flavonoid extract composition comprising at least three flavonoids; and
water.

28. A juice beverage composition comprising:
a citrus flavonoid extract composition comprising at least 700 mg/liter total of hesperidin, narirutin and didymin flavonoids when reconstituted at 11.8° Brix; and
water.

29. The juice beverage composition of claim 28, wherein the citrus flavonoid extract is obtained from the by-product of an orange juice extraction process.
